(19) United States
(12) Patent Application Publication
(10) Pub. No.: US 2025/0327522 A1
(43) Pub. Date: Oct. 23, 2025

(54) CONNECTION DEVICE AND DIAPHRAGM VALVE

(71) Applicant: GEMÜ Gebr. Müller Apparatebau GmbH & Co. Kommanditgesellschaft, Ingelfingen (DE)

(72) Inventors: Johann Magej, Schwäbisch Hall (DE); Martin Rupp, Mulfingen (DE)

(21) Appl. No.: 18/709,102

(22) PCT Filed: Nov. 22, 2022
(86) PCT No.: PCT/EP2022/082714

§ 371 Date: Oct. 4, 2024

(30) Foreign Application Priority Data
Nov. 25, 2021 (DE) 10 2021 130 951.4

(51) Int. Cl. F16K 7/16; F16B 7/04

(52) U.S. Cl. CPC F16K 7/16; F16B 7/0433

(57) ABSTRACT

The invention relates to a connection device (100) for a diaphragm valve, comprising: a receptacle (102a-b) having a distal opening (104) which releases a receiving space (106) for receiving a portion of a diaphragm pin of a valve diaphragm, wherein at least one laterally arranged through-opening of the receptacle (102a-b) leads into the receiving space (106); at least one first securing element which is arranged in the at least one lateral through-opening such that it can move at least perpendicular to a longitudinal axis of the connection device (100); and at least one second securing element (112) which is mounted on the receptacle (102a-b) such that it can move along the longitudinal axis, wherein, in a first position relative to the receptacle (102a-b), the second securing element (112) pushes the at least one first securing element through an inner opening of the at least one through-opening into the receiving space, and wherein, in a second position relative to the receptacle (102a-b), the second securing element (112) releases the first securing element for movement out of the receiving space (106).

The invention relates to a connection device and to a diaphragm valve.

The progress made in the area of process valve technology is described.

One aspect of the description relates to the following subject matter: a connection device for a diaphragm valve or diaphragm seat valve, comprising: a receptacle having a distal opening which releases a receiving space for receiving a section of a diaphragm pin of a valve diaphragm, wherein at least one laterally arranged through-opening of the receptacle leads into the receiving space; at least one first securing element which is arranged in the at least one lateral through-opening such that it can move at least perpendicular to a longitudinal axis of the connection device; and at least one second securing element which is mounted on the receptacle such that it can move along the longitudinal axis, wherein, in a first position relative to the receptacle, the second securing element pushes the at least one first securing element through an inner opening of the at least one through-opening into the receiving space, and wherein, in a second position relative to the receptacle, the second securing element releases the first securing element for movement out of the receiving space.

Advantageously, a force can be introduced into the diaphragm pin by the second securing element, which can be moved to the receptacle, and the engagement of the first securing element in the receptacle. Advantageously, only a small installation space is required for the connection device, which increases the design degrees of freedom for other components. Assembly and disassembly of the diaphragm is accelerated.

An advantageous example is distinguished in that a spring element is supported on the receptacle and the second securing element presses in the direction of the first position.

The second securing element thus always pushes into the second position, in which the at least one first securing element secures the diaphragm or its pin/diaphragm pin in the receiving space.

An advantageous example is distinguished in that the at least one through-hole tapers at least in portions in the direction of the inner opening.

Advantageously, the taper holds the first securing element in the through-hole.

An advantageous example is distinguished in that the second securing element comprises a limiting space which has a first diameter in a first portion in order to press, in the first position, the first securing element into the receiving space through the inner opening of the at least one through-hole, wherein a second portion of the limiting space has a second diameter which is larger than the first diameter in order to release, in the second position, the first securing element for movement out of the receiving space.

The different diameters ensure that different relative rotational positions of the second securing element and the receptacle have no influence on the function of the connection device.

An advantageous example is distinguished in that the second securing element comprises a retaining geometry for reaching the second position.

Advantageously, a separate actuation of the second securing element can thereby be omitted. The drive can thus be used to move the connection device into a mounting position in which the retaining geometry is stationary.

An advantageous example is distinguished in that in the receiving space there is at least one means of protection against a falling out of the diaphragm pin. Advantageously, the means of protection enables haptic feedback to the fitter. The correct mounting is hereby advantageously confirmed.

A further aspect of the description relates to the following subject matter: a diaphragm valve or diaphragm seat valve comprising a drive; a drive rod connected to the drive, which drive rod comprises the connection device according to the preceding aspect, a drive-side body, a valve body; the diaphragm, wherein a lateral portion of the diaphragm is clamped between the valve body and the drive-side body, wherein the second securing element, in its first position relative to the receptacle, presses the first securing element through the inner opening of the at least one through-hole into a taper of the diaphragm pin which is located at least in portions in the receiving space.

The securing elements couple the diaphragm pin and thus the diaphragm to the drive rod when the second securing element is in the first position. If the second securing element is transferred into the second position, the diaphragm can be removed from the drive rod or a new diaphragm can be mounted more quickly.

The taper is a cross-sectional taper perpendicular to the actuating axis and makes it possible for a rotational degree of freedom to remain even when the diaphragm pin is fixed in the receptacle. The diaphragm can thus still be rotated after the diaphragm pin has been introduced into the receiving space. This makes it easier to realize a target rotational position of the diaphragm in relation to a stationary component of the diaphragm valve via coding. In addition, the diaphragm pin can be designed to be rotationally symmetrical relative to the actuating axis at least in the region of the receiving space.

An advantageous example is distinguished in that a compressor is provided, which is arranged between the distal end of the receptacle and the diaphragm.

The compressor, which is freely movable along the actuating axis, is subjected to a force from the distal end of the receptacle in order to close the diaphragm valve or the fluid channel.

An advantageous example is distinguished in that a free distance between the compressor, the diaphragm, and the distal end of the receptacle is smaller than a distance between a bottom of the receptacle space and a distal end of the diaphragm pin.

Advantageously, a closing force can thereby be introduced via the distal end of the receptacle into the compressor and from the compressor into the diaphragm, which presses onto the valve seat. During closing, the closing force is not transmitted via the securing elements. Nevertheless, an opening force that moves the diaphragm away from the valve seat is transmitted via the first securing element to the diaphragm pin and the diaphragm.

An advantageous example is distinguished in that the diaphragm pin is mounted so as to be movable along the actuating axis within the receiving space.

This advantageously has the effect that, during assembly and disassembly, the first securing element can be inserted and removed in a defined manner into the diameter taper of the diaphragm pin.

An advantageous example is distinguished in that the drive transfers the drive rod from at least one operating position into a mounting position in which the second securing element is in the second position.

Advantageously, the diaphragm pin can be fixed or released to the receptacle via the position of the drive rod.

An advantageous example is distinguished in that the retaining geometry of the second securing element meets a stop that is stationary relative to the drive rod during the transition of the drive rod into the mounting position.

The second securing element is thus fixed, whereas the drive rod moves further into the mounting position with the receptacle, and the second securing element releases the receiving space for introducing or removing the diaphragm pin via the first securing element. For assembly with the valve body, the drive rod is retracted again by means of the drive.

In the drawing:

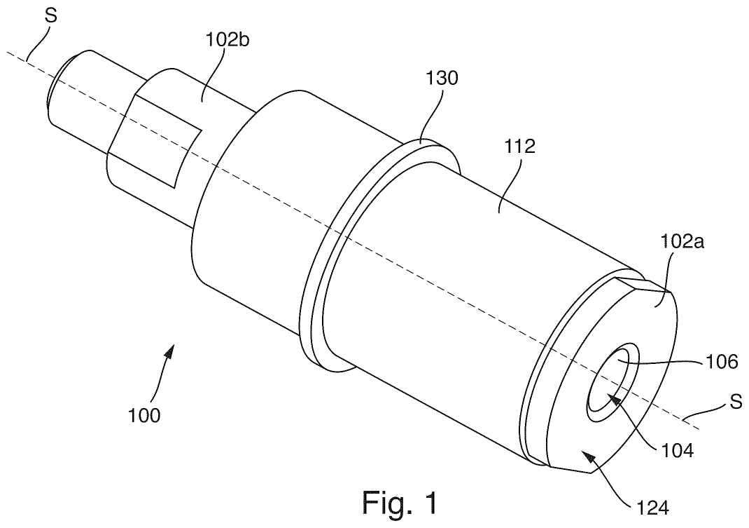

FIG. 1 is a perspective view of a connection device;

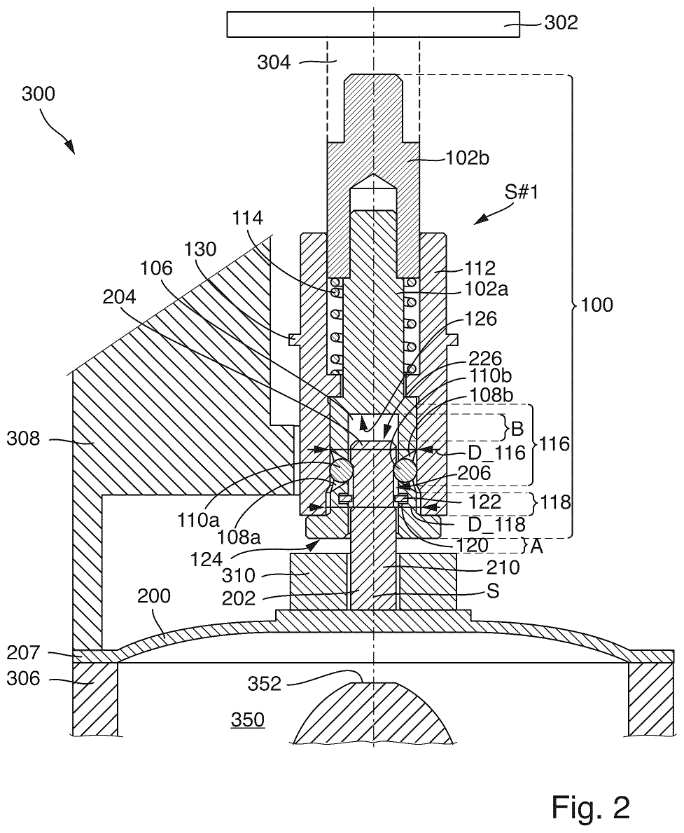

FIG. 2 shows a diaphragm valve in a schematic sectional view;

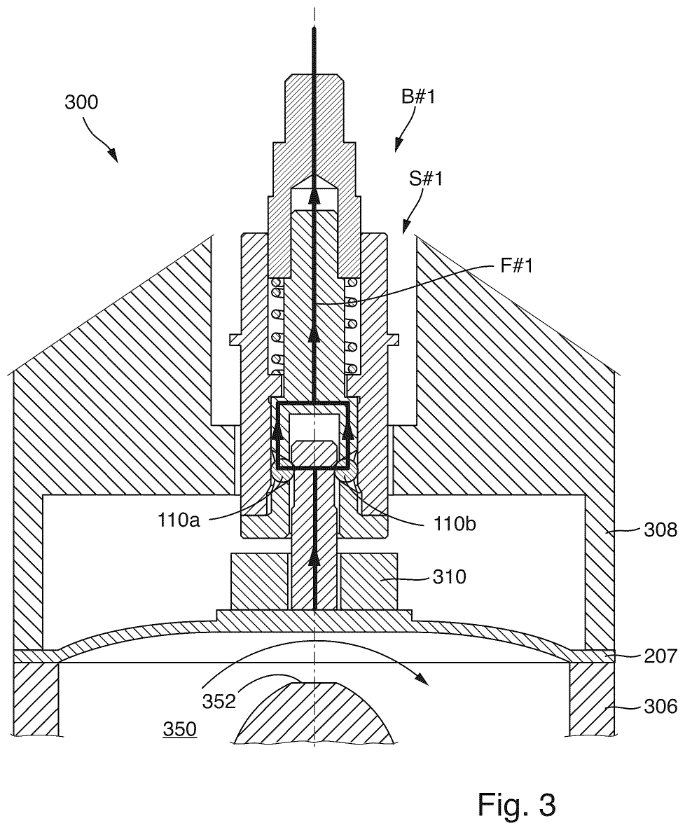

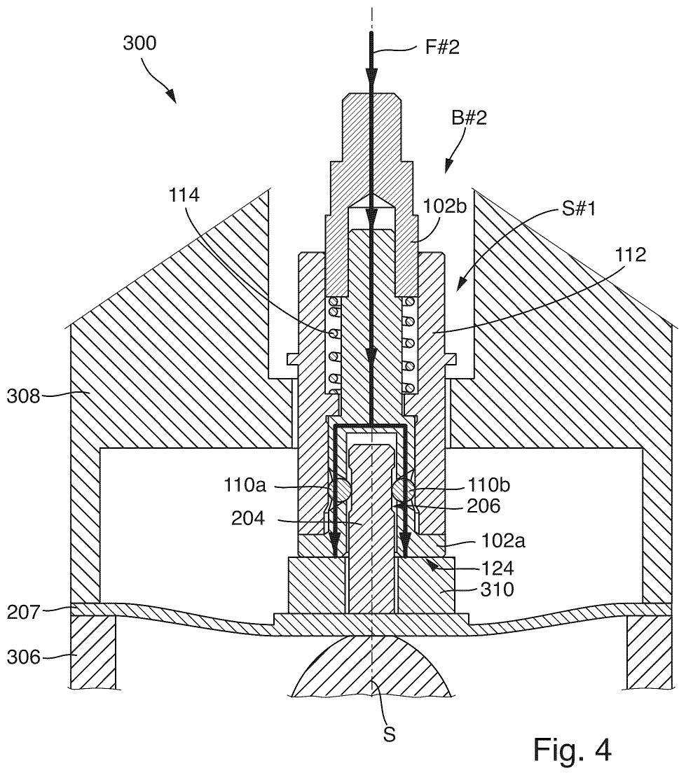

FIGS. 3 and 4 show different operating positions of the drive rod;

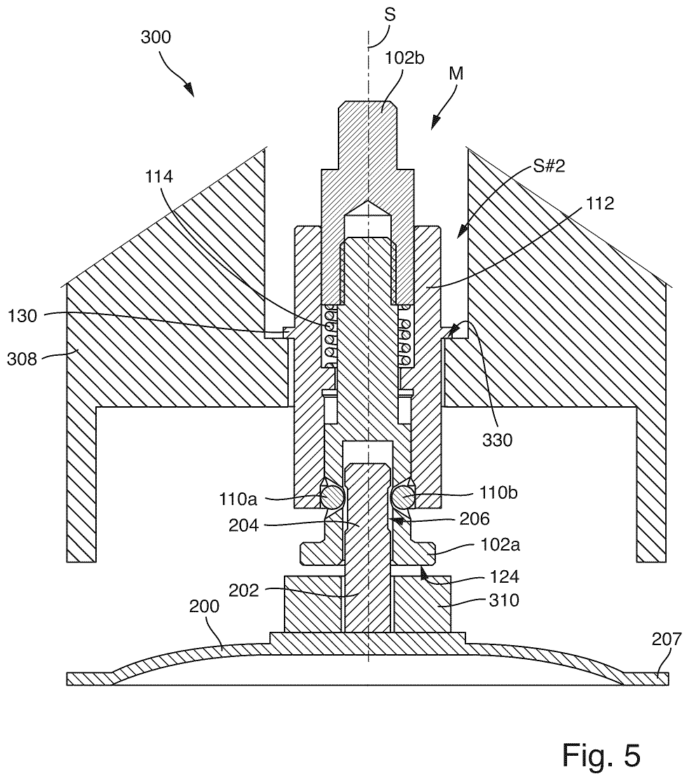

FIG. 5 shows a mounting position of the drive rod.

FIGS. 1 and 2 show a connection device 100. In FIG. 2, a diaphragm valve 300, which comprises the connection device 100, is shown in a schematic section. As an alternative to the example shown, the connecting device 100 can also be used for other types of valves, for example for a diaphragm seat valve (plug-diaphragm valve), in which the shut-off means is diaphragm-like in an outer area and merges into an inner rigid shut-off portion.

A receptacle 102a-b of the connection device 100 comprises a distal opening 104 which releases a receiving space 106 for receiving a portion of a diaphragm pin 202 of a valve diaphragm 200, wherein at least one laterally arranged through-hole 108a-b of the receptacle 102a-b leads into the receiving space 106. The receptacle 102a is designed in the form of a socket which receives the diaphragm pin 202.

A first securing element 102a-b is mounted movably in the lateral through-hole 108a-b at least perpendicular to a central longitudinal axis or longitudinal axis of the connection device 100. In the installed state, the longitudinal axis of the connection device 100 coincides with the actuating axis S of the associated diaphragm valve 300.

A second securing element 112 is movably mounted on the receptacle 102a-b along the longitudinal axis. In a first position S #1 relative to the receptacle 102a-b, the second securing element 112 presses the at least one first securing element 110a-b through an inner opening of the at least one through-hole 108a-b by portions into the receiving space 106. For this purpose, the first securing element 102a-b is dimensioned larger than the wall in which the through-hole 108a-b is located. The at least one through-hole 108a-b tapers in the direction of the inner opening, at least in portions, in particular in the shape of a conical section.

In a second position S #2 visible in FIG. 5 relative to the receptacle 102a-b, the second securing element 112 releases the first securing element 110a-b for movement out of the receiving space 106. This means that the first securing element 110a-b can move into a space released by the second securing element 112.

A spring element 114 in the form of a compression spring is supported on the receptacle 102a-b and presses the second securing element 112 in the direction of the first position S #1. In the first position S #1, the second securing element 112 rests against the receptacle 102a-b.

A diaphragm valve 300 comprises a drive 302 and a drive rod 304 connected to the drive 302, which drive rod comprises the connection device 100. The connection device 100 is arranged at the distal end of the drive rod 304. In the present case, the connection device 100 is designed with a two-part receptacle 102a and 102b. Of course, the receptacle can also be designed differently.

In the example shown, the receptacle 102b is designed as a separate part from the drive rod 304. In an example (not shown), the receptacle 102b is part of the drive rod 304.

For reasons of clarity, the diaphragm valve is shown only on the left-hand side in FIG. 2: a drive-side body 308, for example a drive housing and a valve body 306, arranged stationary relative to the drive 302. The valve body 306 comprises a fluid channel 350, which can be closed by pressing the diaphragm 200 onto a valve seat 352. A lateral portion 207 of the diaphragm 200 is clamped between the valve body 306 and the drive-side body 308. In its first position S #1 relative to the receptacle 102a-b, the second securing element 112 presses the first securing element 110a-b through the inner opening of the through-hole 108a-b by portions into a taper 206 of the diaphragm pin 202, which is designed for example as an outer circumferential groove. The diaphragm pin 202 is located at least in portions in the receiving space 106.

The first securing elements 110a-b thus penetrate into the taper 206, which proximally adjoins the head 204 of the diaphragm pin 202 projecting from the diaphragm 200.

A compressor 310 or a pressure piece is arranged between the distal end 124 of the receptacle 102a-b and the diaphragm 200.

The second element 112 is designed as a sleeve. The second securing element 112 comprises a receiving space for the spring element 114 on the drive side. The second securing element 112 comprises a limiting space on the diaphragm side which has a first diameter D_216 in a first portion 216 arranged pointing away from the diaphragm 200, in order to push, in the first position S #1, the first securing element 110a-b into the receiving space 106 in portions through the inner opening of the at least one through-hole 108a-b. A second portion 118 of the limiting space arranged in the direction of the diaphragm 200 has a second diameter D_118 which is larger than the first diameter D_116 in order to release, in the second position S #2, the first securing element 110a-b for movement out of the receiving space 106.

The second securing element 112 comprises a laterally arranged retaining geometry 130 for reaching the second position S #2 shown in FIG. 5.

In the receiving space 106, there is at least one means of protection against a falling out of the diaphragm pin 202. For example, this means of protection against falling out comprises an inner groove 120 running in a perpendicular plane of the actuating axis S and an elastic O-ring 122 arranged therein, which has a smaller diameter than a head 204 of the diaphragm pin 202. When the diaphragm pin 202 is pushed into the receiving space 106, the fitter thus first senses a mechanical resistance which originates from the impact of the head 204 on the elastic O-ring 122. If the diaphragm pin 202 is pushed further into the receiving space 106, the mechanical resistance is reduced as soon as the O-ring 122 engages in the taper 206 of the diaphragm pin 202. This realizes a securing against loss.

Alternatively or additionally, a captive loss securing means can also be realized in a different manner. For example, a magnet is arranged on a bottom 126 of the receiving space 106. The head 204 of the diaphragm pin 104 is magnetically designed and is thus held captive during mounting via the magnetic retaining force.

A free distance A along or parallel to the actuation axis S between the compressor 310, the diaphragm 200, and the distal end 124 of the receptacle 102a-b is less than a distance B along or parallel to the actuation axis S between the bottom 126 of the receptacle 106 and a distal end 226 of the diaphragm pin 202.

The diaphragm pin 202 is mounted within the receiving space 106 so as to be movable along the actuating axis S. The head 204 and a shaft 210 of the diaphragm pin 202 are separated from one another by the taper 206, wherein a first diameter of the head 204 of the diaphragm pin 202 perpendicular to the actuating axis S and a diameter of the shaft 210 perpendicular to the actuating axis S are matched to the associated inner diameter of the receiving space 106 in such a way that the diaphragm pin 202 is movably mounted within the receiving space 106 along the actuating axis S. In particular, the inner wall of the receiving space 106 of a cylinder jacket inner surface and the outer walls of the head 204 and of the shaft 210 follow a cylinder jacket outer surface. In particular, the first diameter of the head 204 and the second diameter of the shaft 210 are the same size. In an alternative example, the first diameter of the head 204 is smaller than the second diameter of the shaft 210. In an alternative example, the first diameter of the head 204 is greater than the second diameter of the shaft 210. The taper 206 is thus part of a circumferential groove of the diaphragm pin 202. Parallel to the actuating axis S, the circumferential groove is greater than the free distance A, in particular greater than the maximum distance B when the second securing element 112 is in the first position S #1.

The taper 206 is dimensioned parallel to the actuating axis S such that it allows an axial play of the diaphragm pin 202. At the same time, the design allows a rotational play.

FIGS. 3 and 4 show, in a corresponding schematic section, different operating positions B #1 and B #2 of the drive rod. In FIG. 3, the diaphragm 200 is lifted from the valve seat 352, wherein a flow of force F #1 is guided via the first securing elements 110a-b and the diaphragm pin 202. In contrast, in FIG. 4 the securing elements 110a-b are arranged in the taper 206. However, when the diaphragm 200 is pressed onto the seat a flow of force F #2 does not take place via the first securing elements 110a-b. Rather, the distal end 124 of the receptacle 102a presses on the compressor 310, which transfers the introduced force to the diaphragm 200.

FIG. 5 shows the diaphragm 300 without the valve body, in a schematic section. The drive 302 moves the drive rod 304 from at least one of the operating positions in which a fluid channel is open or closed into a mounting position M in which the second securing element 112 is in the second position S #2. During the transition of the drive rod 304 into the mounting position M, the retaining geometry 130 of the second securing element 112 meets a stop 330 which is stationary relative to the drive rod 304, whereby the second securing element 112 is stationary relative to the drive starting from the impact on the stop 330. In the shown mounting position M of the drive rod, the spring element 114 is compressed and allows the first securing element 110a-b to enter into an outer space from the taper 206. The diaphragm pin 202 can thus be removed from the receiving space 106 or another diaphragm pin of another diaphragm can be inserted into the receiving space 106.

1. A diaphragm valve (300) or a diaphragm seat valve comprising:
a drive (302);
a drive rod (304) connected to the drive (302) and comprising a connection device (100);
the connection device (100) comprising:
a receptacle (102a-b) having a distal opening (104) which releases a receiving space (106) for receiving a portion of a diaphragm pin (202) of a valve diaphragm (200), wherein at least one laterally arranged through-hole (108a-b) of the receptacle (102a-b) leads into the receiving space (106);
at least one first securing element (110a-b), which is movably arranged in the at least one lateral through-hole (108a-b) at least perpendicular to a longitudinal axis of the connection device (100); and
at least one second securing element (112), which is mounted on the receptacle (102a-b) so as to be movable along the longitudinal axis, wherein the second securing element (112), in a first position (S #1) relative to the receptacle (102a-b), presses the at least one first securing element (110a-b) into the receiving space (106) through an inner opening of the at least one through-hole (108a-b), and wherein the second securing element (112), in a second position (S #2) relative to the receptacle (102a-b), releases the first securing element (110a-b) for movement out of the receiving space (106);
wherein the drive (302) transfers the drive rod (304) from at least one operating position (B #1, B #2) into a mounting position (M) in which the second securing element (112) is in the second position (S #2).

2. The diaphragm valve (300) or diaphragm seat valve according to claim 1, wherein a spring element (114) is supported on the receptacle (102a-b) and presses the second securing element (112) in the direction of the first position (S #1).

3. The diaphragm valve (300) or diaphragm seat valve according to claim 1 or 2, wherein the at least one through-hole (108a-b) tapers at least in portions in the direction toward the inner opening.

4. The diaphragm valve (300) or diaphragm seat valve according to any one of the preceding claims, wherein the second securing element (112) comprises a limiting space which has a first diameter (D_216) in a first portion (216) in order to press, in the first position (S #1), the first securing element (110a-b) into the receiving space (106) through the inner opening of the at least one through-hole (108a-b), and wherein a second portion (118) of the limiting space has a second diameter (D_118) which is larger than the first diameter (D_116) in order to release, in the second position (S #2), the first securing element (110a-b) for movement from the receiving space (106).

5. The diaphragm valve (300) or diaphragm seat valve according to any one of the preceding claims, wherein the second securing element (112) comprises a retaining geometry (130) for reaching the second position (S #2).

6. The diaphragm valve (300) or diaphragm seat valve according to any one of the preceding claims, wherein in the receiving space (106) there is at least one protective means against a falling out of the diaphragm pin (202).

7. The diaphragm valve (300) or diaphragm seat valve according to any one of the preceding claims, comprising:
the drive (302);
the drive rod (304) connected to the drive (302), which drive rod comprises the connection device (100);
a drive-side body (308);
a valve body (306);
the diaphragm (200), wherein a lateral portion (207) of the diaphragm (200) is clamped between the valve body (306) and the drive-side body (308), wherein the second securing element (112), in its first position (S #1) relative to the receptacle (102a-b), presses the first securing element (110a-b) through the inner opening of the at least one through-hole (108a-b) into a taper (206) of the diaphragm pin (202) which is located at least in portions in the receiving space (106).

8. The diaphragm valve (300) or diaphragm seat valve according to claim 7, comprising:
a compressor (310) which is arranged between the distal end (124) of the receptacle (102a-b) and the diaphragm (200).

9. The diaphragm valve (300) or diaphragm seat valve according to the preceding claim,
wherein a free distance (A) between the compressor (310), the diaphragm (200), and the distal end (124) of the receptacle (102a-b) is smaller than a distance (B) between a bottom (126) of the receptacle space (106) and a distal end (226) of the diaphragm pin (202).

10. The diaphragm valve (300) or diaphragm seat valve according to any one of claims 7 to 9, wherein the diaphragm pin (202) is mounted inside the receiving space (106) so as to be movable along the actuating axis (S).

11. The diaphragm valve (300) or diaphragm seat valve according to claim 5,
wherein the retaining geometry (130) of the second securing element (112) meets a stop (330) stationary relative to the drive rod (304) during the transition of the drive rod (304) into the mounting position (M).

12. A use of the diaphragm valve (300) or diaphragm seat valve according to any one of the preceding claims.
